(19) United States
(12) Patent Application Publication
(10) Pub. No.: US 2026/0358186 A1
(43) Pub. Date: Nov. 12, 2026

(54) DEGRADATION DETERMINATION METHOD, DEGRADATION DETERMINATION DEVICE, AND PROGRAM

(71) Applicant: NTT, Inc., Tokyo (JP)

(72) Inventors: Yosuke TAKEUCHI, Tokyo (JP); Mizuki TABATA, Tokyo (JP); Ryo MAKINO, Tokyo (JP); Junichiro TAMAMATSU, Tokyo (JP)

(73) Assignee: NTT, Inc., Tokyo (JP)

(21) Appl. No.: 19/131,846

(22) PCT Filed: Nov. 24, 2022
(86) PCT No.: PCT/JP2022/043399

§ 371 Date: May 21, 2025

(51) Int. Cl. G01M 5/00

(52) U.S. Cl. CPC G01M 5/0033; G01M 5/0041

(57) ABSTRACT

A deterioration determination method according to the present disclosure is a deterioration determination method performed by a deterioration determination device (1) that determines deterioration of a structure (2) having a plurality of surface members (21 to 23) defining an internal space (IS), the deterioration determination method including: an input step of receiving an input of displacement information regarding displacement (d) of a target region (2a) in a predetermined surface member (21) among the plurality of surface members (21 to 23); and a determination step of determining whether the structure (2) is deteriorated on the basis of the displacement information.

### TECHNICAL FIELD

The present disclosure relates to a deterioration determination method, a deterioration determination device, and a program.

### BACKGROUND ART

Some manholes, which are social infrastructure, have been installed for over 50 years. With such lapse of years, in particular, a manhole having a box shape is deformed by application of pressure from the surroundings due to a load associated with soil pressure, a road surface active load, and the like, and cracks (including crushing) may occur. The manhole is formed of concrete and a reinforcing bar, and when a crack occurs in the concrete, water may enter from the cracked part and reach the reinforcing bar inside the concrete. As a result, corrosion of the reinforcing bar progresses, and the reinforcing bar becomes thin (leading to recession), and thus, there is a possibility that structural strength of the manhole decreases.

In addition, since a path from the outside to the inside of the manhole is formed by the crack, earth and sand, water, and the like in the ground in which the manhole is disposed flow into the manhole. This may cause a danger for a worker who performs work in the internal space of the manhole, or reduce work efficiency.

Therefore, in order to maintain and manage a reinforced concrete structure such as a manhole, it is considered important to accurately detect deterioration such as cracks. At present, cracks of the reinforced concrete structure, exposed streaks associated with cracks, and the like are visually checked. As a device for monitoring a crack, a method using a strain gauge (Non Patent Literature 1), a method using an optical fiber sensor (Non Patent Literatures 2 and 3), a method of electrochemically detecting corrosion of a reinforcing bar (Non Patent Literature 4), and the like are known.

### CITATION LIST

### Non Patent Literature

Non Patent Literature 1: “Crack Detection Sensor for Concrete|Tokyo Measuring Instruments Laboratory Co., Ltd.”, [online], [retrieved on Nov. 9, 2022], the Internet <https://tml.jp/knowledge/special_ins/crack_detection.html>
Non Patent Literature 2: “Kisetsu kouzoubutsu no monitaringu shisutemu no kaihatsu (in Japanese) (Development of monitoring system for existing structure)|Research and Development|Railway Technical Research Institute”, [online], [retrieved on Nov. 9, 2022], the Internet <https://www.rtri.or.jp/rd/division/rd43/rd4310/rd43100128. html>
Non Patent Literature 3: Yutaka Murase and three others, “Hibiware wo yuusuru tekkin konkurito kabe buzai no hikari faiba ni yoru monitaringu (in Japanese) (Monitoring of reinforced concrete wall members having cracks by optical fiber)”, Proceedings of the Japan Concrete Institute, 2003, Vol. 25, No. 1, p. 1703-1708
Non Patent Literature 4: Kotaro Doi, “Diagnostic Technique for Corrosion of Reinforcing Steel Inside Concrete”, Materia Japan, 2020, Vol. 59, No. 6, p. 313-320

### SUMMARY OF INVENTION

### Technical Problem

However, in the above-described technology, it is difficult to check a crack in a range that cannot be inspected visually or by measurement from the internal space side of the reinforced concrete structure. A method of digging soil in the vicinity of a manhole buried under the ground and checking whether a crack occurs on the outside of a reinforced concrete structure, a method of disposing an optical fiber sensor outside a manhole and detecting a crack on the outside of the manhole using the optical fiber, and the like are conceivable, but these methods are not practical because they require a lot of cost and labor. As described above, it is difficult to determine deterioration of a structure with high accuracy because it is difficult to check a crack in a range that cannot be inspected visually or by measurement from the internal space side of the reinforced concrete structure.

An object of the present disclosure made in view of such circumstances is to provide a deterioration determination method, a deterioration determination device, and a program capable of determining deterioration of a structure with high accuracy.

### Solution to Problem

In order to solve the above problem, a deterioration determination method according to the present disclosure is a deterioration determination method performed by a deterioration determination device that determines deterioration of a structure having a plurality of surface members defining an internal space, the deterioration determination method including: an input step of receiving an input of displacement information regarding displacement of a target region in a predetermined surface member among the plurality of surface members; and a determination step of determining whether the structure is deteriorated on the basis of the displacement information.

In order to solve the above problem, a deterioration determination device according to the present disclosure is a deterioration determination device that determines deterioration of a structure having a plurality of surface members defining an internal space, the deterioration determination device including: an input unit that receives an input of displacement information regarding displacement of a target region in which a direction of the displacement changes according to deterioration of the structure in a predetermined surface member among the plurality of surface members; and a determination unit that determines whether the structure is deteriorated on the basis of the displacement information.

In order to solve the above problem, a program according to the present disclosure causes a computer to execute the deterioration determination method described above.

### Advantageous Effects of Invention

According to a deterioration determination method, a deterioration determination device, and a program according to the present disclosure, it is possible to determine deterioration of a structure with high accuracy.

### BRIEF DESCRIPTION OF DRAWINGS

FIG. 1 is a schematic diagram illustrating an example of a deterioration determination device according to an embodiment of the present disclosure.

FIG. 2 is a perspective view illustrating an example of a manhole which is an example of a structure in which deterioration is detected by the deterioration determination device illustrated in FIG. 1.

FIG. 3A is a schematic view for explaining stress generated in a state in which deterioration does not occur in the manhole illustrated in FIG. 2.

FIG. 3B is a schematic view illustrating a crack generated in a manhole by the stress illustrated in FIG. 3A.

FIG. 3C is a schematic view illustrating that an upper surface member of the manhole is simply supported due to occurrence of deterioration such as a crack illustrated in FIG. 3B.

FIG. 3D is a schematic view for explaining stress in the manhole illustrated in FIG. 3C.

FIG. 4A is a diagram schematically illustrating the manhole illustrated in FIG. 2.

FIG. 4B is a top view illustrating the manhole illustrated in FIG. 4A.

FIG. 5 is a diagram illustrating an example of a change over time of displacement in a target region.

FIG. 6 is a diagram illustrating an example of a determination result output by the deterioration determination device illustrated in FIG. 1.

FIG. 7 is a flowchart illustrating an example of operation performed by the deterioration determination device illustrated in FIG. 1.

FIG. 8 is a diagram illustrating an example of a hardware configuration of the deterioration determination device illustrated in FIG. 1.

### DESCRIPTION OF EMBODIMENTS

### <Configuration of Deterioration Determination Device>

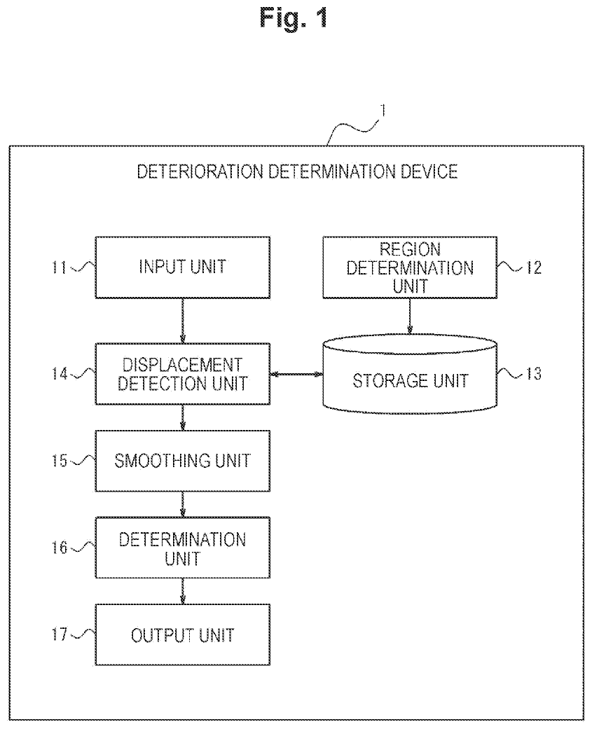

A deterioration determination device 1 of the present embodiment will be described with reference to FIG. 1. FIG. 1 is a schematic diagram illustrating an example of the deterioration determination device 1 according to the present embodiment.

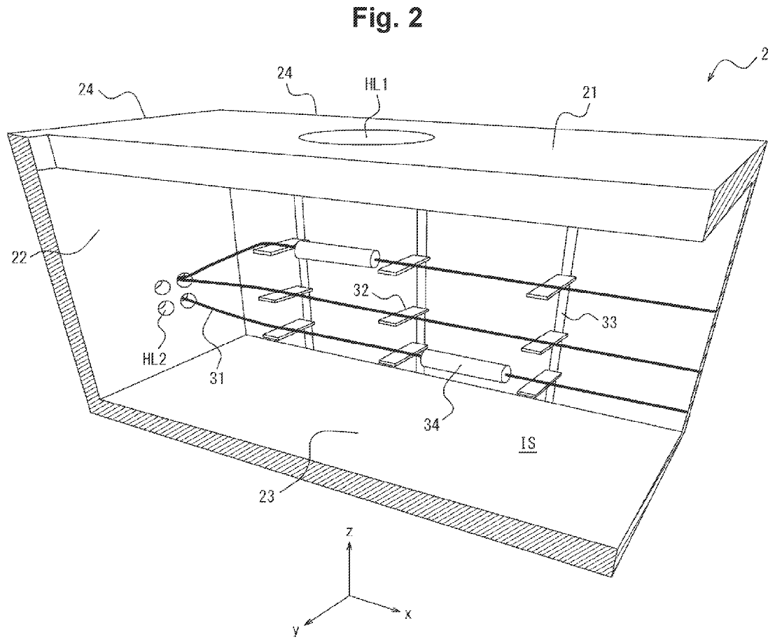

The deterioration determination device 1 determines deterioration of a structure 2 as illustrated in FIG. 2. The structure 2 may be, for example, a manhole and may be disposed underground. In FIG. 2, two surface members of the manhole are omitted to describe an internal space IS of the manhole.

The structure 2 has a plurality of surface members 21 to 23 defining the internal space IS. In this example, the plurality of surface members include an upper surface member 21, a side surface member 22, and a lower surface member 23. As an example, the upper surface member 21 is an upper floor slab, the side surface member 22 is a side wall, and the lower surface member 23 is a lower floor slab.

Each of the upper surface member 21, the side surface member 22, and the lower surface member 23 may be made of a reinforcing bar and concrete covering the reinforcing bar. A hole HL1 through which a worker or the like enters and exits may be defined in the upper surface member 21. A cable hole HL2 through which a cable such as a communication cable passes may be defined in the side surface member 22 of the structure 2.

The plurality of surface members 21 to 23 form corner portions 24 which are bent portions of the structure 2. In this example, the corner portion 24 is formed at each of a joint portion between the upper surface member 21 and the side surface member 22, a joint portion between the two side surface members 22, and a joint portion between the side surface member 22 and the lower surface member 23. In a state where the structure 2 is not deteriorated (a crack does not progress), the upper surface member 21, the side surface member 22, and the lower surface member 23 constitute the structure 2 by a rigid frame structure.

A cable 31 may be inserted into the internal space IS from the outside through the cable hole HL2. In the internal space IS, a distribution member 32 that distributes the cable 31 may be attached to the side surface member 22 by a support member 33. A terminal box 34 may be disposed in the internal space IS. The members provided in the internal space IS is not limited to these examples, and any member according to the use of the structure 2 may be provided in the internal space IS.

Here, the principle by which the deterioration determination device 1 determines deterioration of the structure 2 will be described. Although the principle of determining deterioration based on the displacement of the upper surface member 21 will be described in this description, this principle can also be applied to the side surface member 22 and the lower surface member 23.

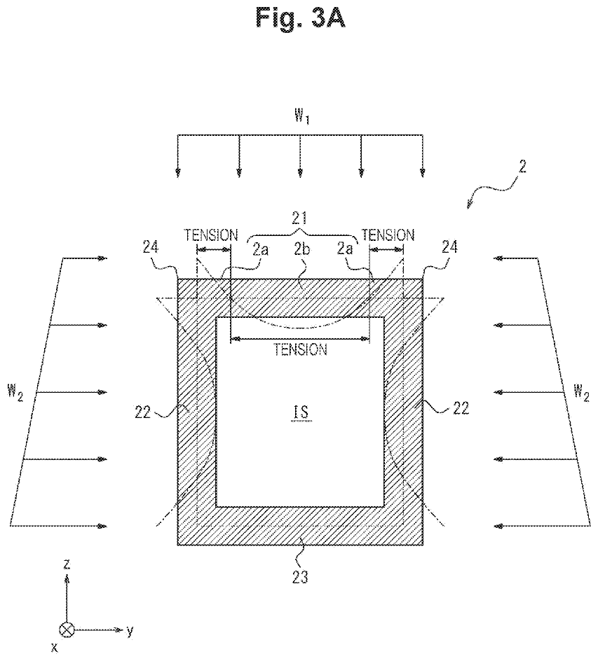

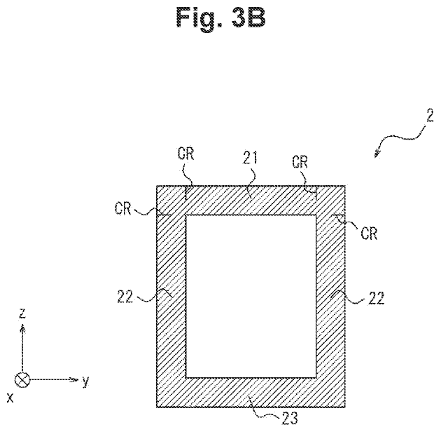

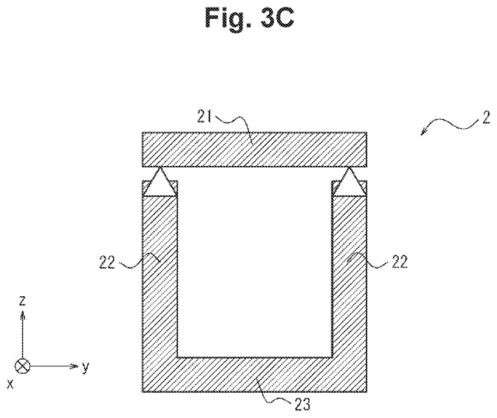

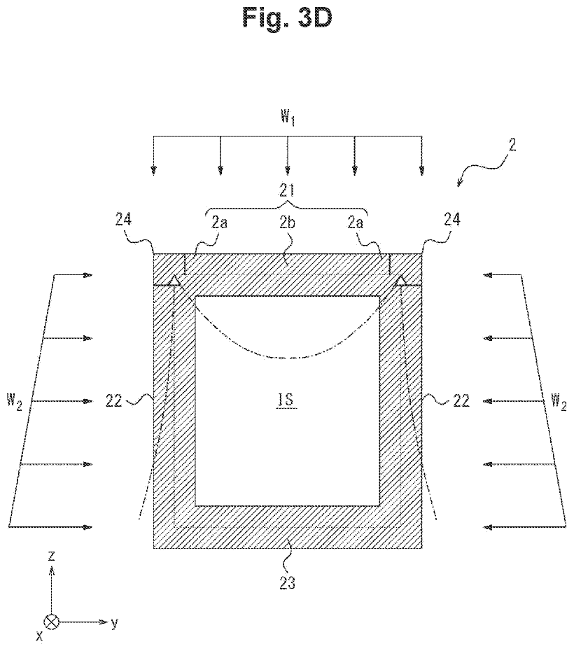

As illustrated in FIG. 3A, when the structure 2 is not deteriorated, when a load W₁ from above and a load W₂ from a side are applied to the structure 2, in the upper surface member 21, the target region 2a is displaced outward by tensile stress from the outside, and a non-target region 2b located closer to the center than the target region 2a is displaced toward the internal space IS side by tensile stress from the internal space IS side. For example, as described above, when the structure 2 is buried in the ground, the load from above is a load generated by soil on the ground surface side of the structure 2, an object disposed on the ground surface, a vehicle passing on the ground surface, and the like.

The target region 2a is a region in which a direction of displacement changes according to deterioration of the structure. Specifically, the target region 2a is a partial region of a predetermined surface member (for example, upper surface member 21) among the plurality of surface members 21 to 23. As described above, in the configuration in which the structure 2 has the corner portion 24, the target region 2a is a part of the predetermined surface member and is a region on a side of the corner portion 24. Specifically, the target region is a region on the side of the corner portion 24 from a deflection point of a bending moment of when deterioration does not occur in the structure 2 in the predetermined surface member.

When a load is applied to the structure 2 from the upper side, as illustrated in FIG. 3B, a crack CR is generated in a region of the structure 2 where a tensile load is applied to the outside, that is, in the vicinity of the corner portion 24. Then, when the crack CR progresses, as illustrated in FIG. 3C, the upper surface member 21 of the structure 2 approaches a state of being simply supported from a state of forming the rigid frame structure. The simple supporting means being supported at a point (in the example illustrated in FIG. 3C, the upper vertex of the triangle symbol) by another member (side surface member 22). Then, when a load W₁ from above and a load W₂ from the side are applied to the simply supported upper surface member 21, as illustrated in FIG. 3D, in the upper surface member 21, both the target region 2a and the non-target region 2b are displaced to the internal space IS side by the tensile stress from the internal space IS side.

As described above, when the crack CR of the structure 2 has not progressed (the structure has not deteriorated), the target region 2a is displaced outward, and on the other hand, when the crack CR of the structure 2 has progressed (the structure has deteriorated), the displacement to the outside in the target region 2a decreases. Further, when the crack CR progresses, the target region 2a is displaced toward the internal space IS side. Therefore, the deterioration determination device 1 can determine deterioration of the structure 2 on the basis of the displacement of the target region 2a.

As illustrated in FIG. 1, the deterioration determination device 1 includes an input unit 11, a region determination unit 12, a storage unit 13, a displacement detection unit 14, a smoothing unit 15, a determination unit 16, and an output unit 17. The input unit 11 includes an input interface. The input interface may be a communications interface. For the communication interface, for example, a standard such as Ethernet (registered trademark), fiber distributed data interface (FDDI), or Wi-Fi (registered trademark) may be used. The region determination unit 12, the displacement detection unit 14, the smoothing unit 15, and the determination unit 16 are configured by a controller. The controller may include dedicated hardware such as an application specific integrated circuit (ASIC) or a field-programmable gate array (FPGA), may include a processor, or may include both the dedicated hardware and the processor. The storage unit 13 includes a memory. The memory may include a hard disk drive (HDD), a solid state drive (SSD), an electrically erasable programmable read-only memory (EEPROM), a read-only memory (ROM), and a random access memory (RAM). The output unit 17 includes an output interface. The output interface may be a communications interface.

The input unit 11 receives an input of displacement information regarding displacement d of the target region 2a in which the direction of displacement changes according to deterioration of the structure 2 in a predetermined surface member (for example, upper surface member 21) among the plurality of surface members 21 to 23.

The displacement information may be signal information indicating the displacement d of the target region 2a measured by a displacement measuring device such as a strain gauge, a contact gauge, or a displacement meter. Furthermore, the displacement information may be image information indicating an image of the target region 2a captured by the imaging device. Furthermore, the displacement information may be information indicating a numerical value itself indicating the displacement d of the target region 2a. The displacement information may be acquired by a worker in the internal space IS of the structure 2. However, the crack CR is generated in the structure 2, and there is a possibility that the structure 2 is damaged due to the crack CR. Therefore, it is preferable to use any technology that can acquire displacement information without allowing the worker to enter the internal space IS of the structure 2 and that ensures safety. If it is confirmed by any test or the like that the internal space IS of the structure 2 is safe, the worker may enter the internal space IS of the manhole and acquire the displacement information.

The displacement information may include information on the displacement d that changes over time. The input unit 11 may receive the input of the displacement information at predetermined time intervals or may irregularly receive the input of the displacement information.

The region determination unit 12 determines the target region 2a in which the displacement direction changes according to the deterioration of the structure described above. For example, the region determination unit 12 may determine a region that is a part of the predetermined surface member 21 to 23 and is on a side of the corner portion 24 as the target region 2a. Specifically, the region determination unit 12 may determine, as the target region 2a, a region of the predetermined surface member 21 to 23 on the side of the corner portion 24 from the deflection point of the bending moment of when no deterioration occurs in the structure 2.

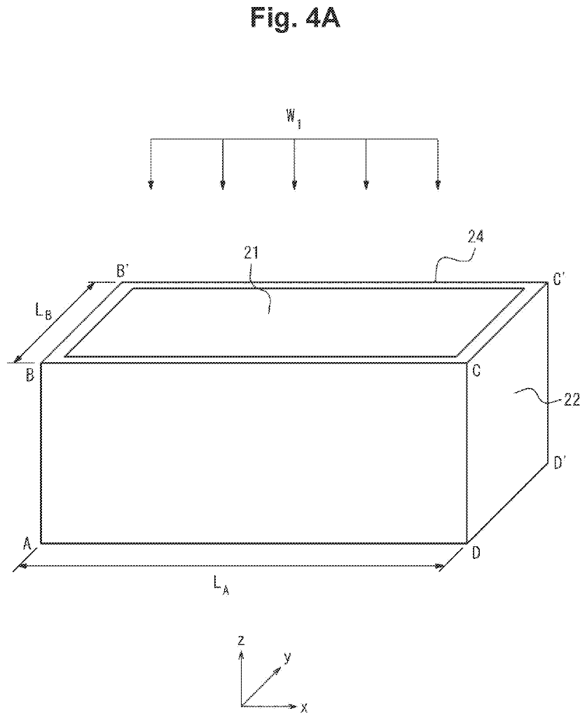

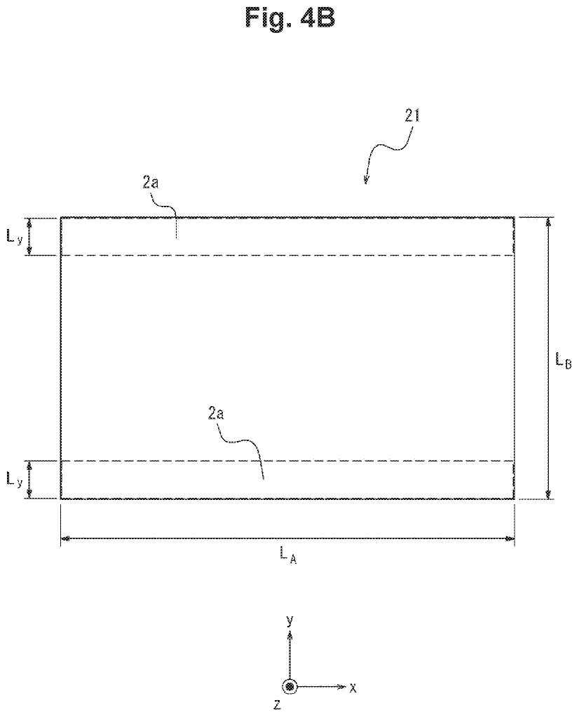

In the example illustrated in FIGS. 4A and 4B, the region determination unit 12 can determine, as the target region 2a, a region that is equal to or less than a length Ly expressed by the following Expression (1) in a y-axis direction from a side extending in an x-axis direction in the upper surface member 21. In Expression (1), M_{BC} is a bending moment generated at vertex B, and S_{BC} is a shearing force generated at point B. As described above, W₁ is a load applied to the structure 2 from above, that is, a load applied to the upper surface member 21.

$$\begin{matrix}[ Math . 1 ] & \\ {L}_{y} = \frac{{S}_{BB ′} \pm \sqrt{{S}_{BB ′}^{2} + 2 {W}_{1} \cdot {M}_{BB ′}}}{{W}_{1}} & ( 1 )\end{matrix}$$

As similar to this, the region determination unit 12 can determine, as the target region 2a, a region that is equal to or less than a length Lₓ expressed by the Expression (2) in an x-axis direction from a side extending in a y-axis direction in the upper surface member 21.

$$\begin{matrix}[ Math . 2 ] & \\ {L}_{x} = \frac{{S}_{BC} \pm \sqrt{{S}_{BC}^{2} + 2 {W}_{1} \cdot {M}_{BC}}}{{W}_{1}} & ( 2 )\end{matrix}$$

The storage unit 13 stores region information indicating the target region 2a determined by the region determination unit 12.

The displacement detection unit 14 detects the displacement d of the target region 2a in the structure 2 on the basis of the displacement information input by the input unit 11. Specifically, the displacement detection unit 14 detects the displacement d at a predetermined position in target region 2a. The predetermined position may be any position in the target region 2a. As illustrated in FIG. 4B, when target region 2a is a region extending in the x-axis direction, the predetermined position is desirably a center in the x-axis direction (that is, a position where a distance from one end portion in the x-axis direction is L_{A}/2). As similar to this, when target region 2a is a region extending in the y-axis direction, the predetermined position is desirably a center in the y-axis direction (that is, a position where a distance from one end portion in the y-axis direction is L_{B}/2).

In the configuration in which the input unit 11 receives the displacement information of each position of the structure 2, the displacement detection unit 14 may extract the displacement information of the target region 2a indicated by the region information stored in the storage unit 13, and detect the displacement d on the basis of the displacement information. In the configuration in which the input unit 11 receives the input of the displacement information of the position in the target region 2a, the displacement detection unit 14 may detect the displacement d on the basis of the received displacement information of the target region 2a.

As an example, when the displacement information is signal information indicating the displacement d measured using a measuring device, the displacement detection unit 14 can detect the displacement d of the target region 2a on the basis of the signal information. As another example, when the displacement information is image information indicating an image obtained by imaging the target region 2a by the imaging device, the displacement detection unit 14 can detect the displacement d of the target region 2a on the basis of the image information by using any method such as a digital image correlation method. As still another example, when the displacement information is a numerical value itself indicating the displacement d of the target region 2a, the displacement detection unit 14 can detect the numerical value as the displacement d.

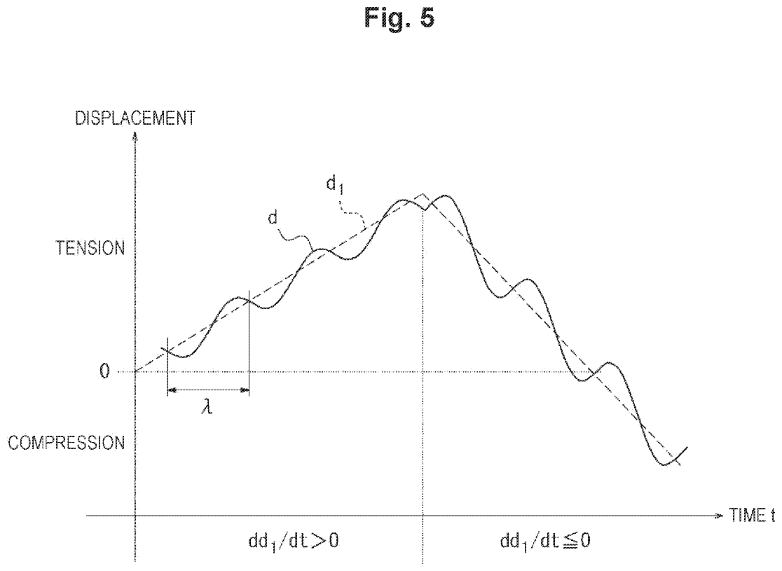

The smoothing unit 15 smooths a change over time of the displacement d detected by the displacement detection unit 14. Specifically, the smoothing unit 15 calculates a long-term temporal change of the displacement d. The long-term temporal change is a temporal change of the displacement d at a frequency lower than the frequency of the temporal change of the load assumed in the environment where the structure 2 is provided. As a result, the smoothing unit 15 can remove the temporal change of the displacement d due to the short-term stress fluctuation. For example, as illustrated in FIG. 5, the smoothing unit 15 may calculate a wavelength A from a waveform (solid line in FIG. 5) indicating a change over time of the displacement d by fast Fourier transform (FFT), and perform smoothing processing (broken line in FIG. 5) such that the wavelength λ is longer than the wavelength λ. In FIG. 5, the outward displacement from the initial position is described as positive displacement (tension), and the displacement from the initial position to the internal space IS side is described as negative displacement (compression).

The determination unit 16 determines whether the structure 2 is deteriorated on the basis of the displacement d of the target region 2a in the structure 2.

For example, when displacement d to the outside of structure 2 in the target region 2a is positive displacement, the determination unit 16 may determine whether time derivative dd₁/dt of smoothed displacement d₁ that is the displacement d in which the change over time has been smoothed by the smoothing unit 15, is greater than 0. The determination unit 16 may determine that the structure 2 is not deteriorated when determining that the time derivative of the smoothed displacement d₁ is greater than 0, and may determine that the structure 2 is deteriorated when the time derivative dd₁/dt of the smoothing displacement d₁ is equal to or less than 0.

When the determination unit 16 determines that the structure 2 is deteriorated (when the time derivative dd₁/dt is equal to or less than 0), the determination unit 16 may determine that the smaller the smoothed displacement d₁, the higher the degree of deterioration of the structure 2. For example, the determination unit 16 may determine whether the smoothed displacement d₁ is greater than 0, and when the smoothing displacement d₁ is determined to be equal to or less than 0, it may be determined that the structure 2 is more deteriorated as it is in a dangerous state.

When displacement d to the outside of the structure 2 in the target region 2a is positive displacement, the determination unit 16 may determine whether the displacement d from the initial position of the target region 2a is greater than 0. The initial position is, for example, a position of the target region 2a when the structure 2 is newly installed. In such a configuration, when the displacement d is determined to be equal to or less than 0, the determination unit 16 may determine that the structure 2 is deteriorated.

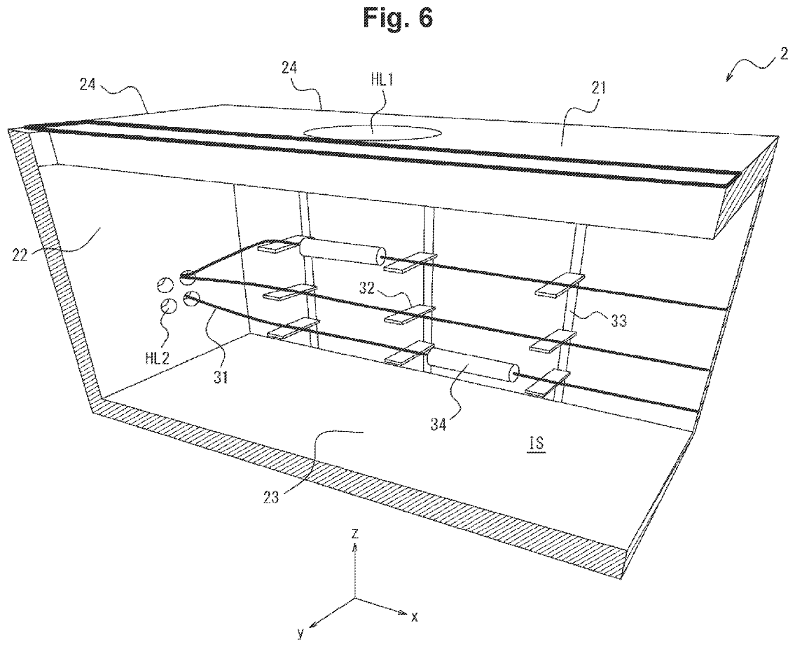

The output unit 17 outputs the determination result determined by the determination unit 16. For example, the output unit 17 may display the determination result on a display device configured integrally with or separately from the deterioration determination device 1. At this time, as illustrated in FIG. 6, the output unit 17 can display an image of the structure 2 and display a mark (in the example of FIG. 6, a rectangle of thick line in the upper surface member 21) surrounding the target region 2a determined to be deteriorated in the image. In such an example, the manager, the worker, and the like of the structure 2 can intuitively recognize the region where the crack CR causing the deterioration is expected to progress by referring to the determination result displayed by the display device.

Furthermore, the output unit 17 may output the determination result to another device via a communication network, or may output the determination result by any method such as voice.

### <Operation of Deterioration Determination Device>

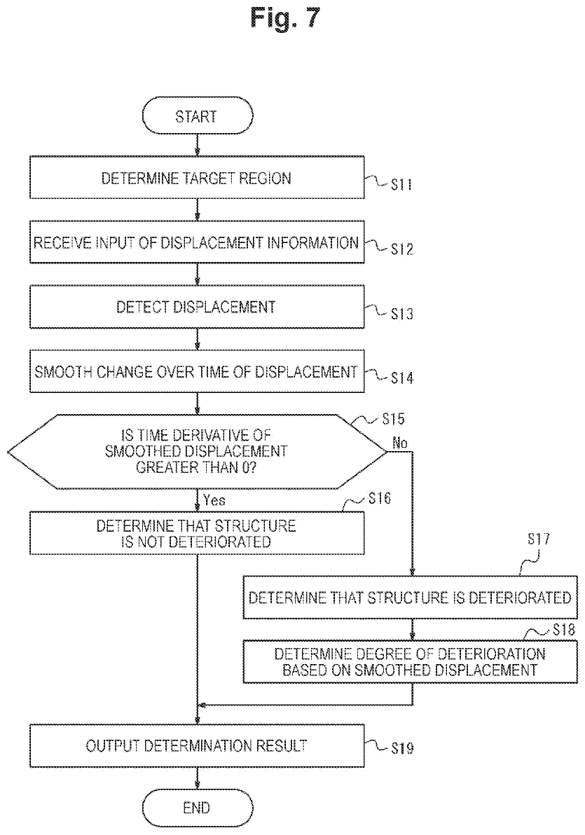

Here, the operation of the deterioration determination device 1 according to the present embodiment will be described with reference to FIG. 7. FIG. 7 is a flowchart showing an example of the operation of the deterioration determination device 1 according to the present embodiment. The operation of the deterioration determination device 1 described with reference to FIG. 7 corresponds to an example of a deterioration determination method of the deterioration determination device 1 that determines deterioration of the structure 2 in which the internal space IS is defined by the plurality of surface members 21 to 23 and the corner portion 24 is formed according to the present embodiment.

In step S11, the region determination unit 12 determines the target region 2a in which the displacement direction changes according to the deterioration of the structure 2.

In step S12, the input unit 11 receives an input of displacement information regarding displacement of the target region 2a in which the direction of displacement changes according to deterioration of the structure 2 in a predetermined surface member among the plurality of surface members 21 to 23 (input step).

In step S13, the displacement detection unit 14 detects the displacement d of the target region 2a in the structure 2 on the basis of the displacement information (displacement detection step).

In step S14, the smoothing unit 15 smooths the change over time of the displacement d (smoothing step).

Subsequently, the determination unit 16 determines whether the structure 2 is deteriorated on the basis of the displacement d based on the displacement information (determination step).

In step S15, when displacement d of the target region 2a is positive displacement, the determination unit 16 determines whether time derivative of smoothing displacement d₁, which is smoothed displacement d, is greater than 0.

If it is determined in step S15 that the time derivative of the smoothed displacement d₁ is greater than 0, the determination unit 16 determines in step S16 that the structure 2 is not deteriorated.

If it is determined in step S15 that the time derivative of the smoothed displacement d₁ is equal to or less than 0, the determination unit 16 determines in step S17 that the structure 2 is deteriorated.

In step S18, the determination unit 16 determines the degree of deterioration of the structure 2 on the basis of the smoothed displacement d₁. Specifically, the determination unit 16 determines that the degree of deterioration of the structure 2 is higher as the smoothed displacement d₁ is smaller. For example, the determination unit 16 may determine whether the smoothed displacement d₁ is greater than 0, and when the smoothed displacement d₁ is determined to be equal to or less than 0, it may be determined that the structure 2 is more deteriorated as it is in a dangerous state.

In step S19, the output unit 17 outputs the determination result determined in the determination step.

The deterioration determination device 1 may not perform step S11 described above. In this case, the deterioration determination device 1 may receive an input of information indicating the target region 2a determined by another device, and may receive an input of displacement information related to displacement measured on the basis of the information. The deterioration determination device 1 may not perform step S18 described above.

As described above, a deterioration determination method according to the present embodiment is a deterioration determination method performed by a deterioration determination device 1 that determines deterioration of a structure 2 having a plurality of surface members 21 to 23 defining an internal space IS, the deterioration determination method including: an input step of receiving an input of displacement information regarding displacement d of a target region 2a in which a direction of displacement changes according to deterioration of the structure 2 in a predetermined surface member among the plurality of surface members 21 to 23; and a determination step of determining whether the structure 2 is deteriorated on the basis of the displacement information.

As a result, deterioration of the structure 2 due to the crack CR or the like that cannot be check from the internal space IS side can be determined using the displacement information. Therefore, as compared with the conventional case where deterioration of the structure 2 is determined on the basis of the crack CR checked from the internal space IS side, in the deterioration determination method according to the present embodiment, it is possible to determine deterioration of the structure with high accuracy. Accordingly, since the manager of the structure 2 can appropriately maintain and manage the structure 2, the probability that the structure 2 is safely used increases. In particular, in the structure 2 provided in the ground, there is a high possibility that the crack CR is generated in the upper surface member 21 by receiving a high load from the ground surface side. Therefore, in the configuration in which the predetermined member is the upper surface member 21, this determination method exhibits a particularly remarkable effect and is useful.

In the deterioration determination method according to the present embodiment, the displacement information includes information indicating displacement that changes over time, the deterioration determination method further includes a smoothing step of smoothing a change over time of the displacement d, and the determination step includes a step of determining whether a time derivative dd₁/dt of a smoothed displacement d₁ that is the displacement d in which the change over time has been smoothed is greater than 0 when the displacement d to the outside of the structure 2 in the target region is positive displacement, determining that the structure 2 is not deteriorated when the time derivative dd₁/dt of the smoothing displacement d₁ is greater than 0, and determining that the structure 2 is deteriorated when the time derivative dd₁/dt of the smoothing displacement d₁ is equal to or less than 0. As a result, it can be determined that the structure 2 is deteriorated.

In the deterioration determination method according to the present embodiment, in the determination step, it is determined whether the displacement d from the initial position of the target region 2a is greater than 0 when the displacement d to the outside of the structure 2 in the target region 2a is positive displacement, and, when the displacement d is determined to be equal to or less than 0, it is determined that the structure 2 is deteriorated. As a result, it can be determined that the deterioration has progressed and the structure 2 is in a dangerous state.

### Modification

In the embodiment described above, the deterioration determination device 1 includes the region determination unit 12 and the storage unit 13, but is not limited thereto. For example, the deterioration determination device 1 may not include the region determination unit 12 and the storage unit 13, and another device or the like may determine the target region 2a by any method. In such a configuration, the input unit 11 may receive an input of displacement information indicating the determined displacement d of the target region 2a, and the displacement detection unit 14, the smoothing unit 15, and the determination unit 16 may perform the above-described processing on the basis of the displacement d indicated by the displacement information.

### <Program>

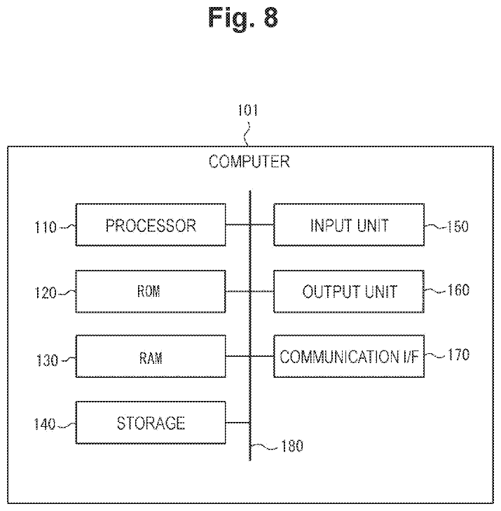

The deterioration determination device 1 described above can be realized by a computer 101. In addition, a program for causing the computer 101 to function as the deterioration determination device 1 may be provided. In addition, the program may be stored in a storage medium or may be provided via a network. FIG. 8 is a block diagram illustrating a schematic configuration of a computer 101 that functions as the deterioration determination device 1. Here, the computer 101 may be a general-purpose computer, a dedicated computer, a workstation, a personal computer (PC), an electronic notepad, or the like. The program command may be program code, a code segment, or the like for executing a necessary task.

As illustrated in FIG. 8, the computer 101 includes a processor 110, a read only memory (ROM) 120, a random access memory (RAM) 130, a storage 140, an input unit 150, an output unit 160, and a communication interface (I/F) 170. The components are communicatively connected to each other via a bus 180. Specifically, the processor 110 is a central processing unit (CPU), a micro processing unit (MPU), a graphics processing unit (GPU), a digital signal processor (DSP), a system on a chip (SoC), or the like, and may include a plurality of processors of the same or different types.

The processor 110 executes control on the components and various types of arithmetic processing. That is, the processor 110 reads a program from the ROM 120 or the storage 140 and executes the program by using the RAM 130 as a work region. The processor 110 controls the components described above and performs various types of arithmetic processing according to the program stored in the ROM 120 or the storage 140. In the embodiments described above, the program according to the present disclosure is stored in the ROM 120 or the storage 140.

The program may be stored in a storage medium that can be read by the computer 101. By using such a storage medium, it is possible to install the program in the computer 101. Here, the storage medium in which the program is stored may be a non-transitory storage medium. The non-transitory storage medium is not particularly limited, but may be, for example, a CD-ROM, a DVD-ROM, or a universal serial bus (USB) memory. The program may be downloaded from an external device via a network.

The ROM 120 stores various programs and various types of data. The RAM 130 temporarily stores a program or data as a working region. The storage 140 includes a hard disk drive (HDD) or a solid state drive (SSD), and stores various programs including an operating system and various types of data.

The input unit 150 is an interface for receiving an input of information, and the output unit 160 is an interface for outputting information.

The communication interface 170 is an interface communicating with an external device.

With regard to the above embodiments, the following supplementary notes are further disclosed.

### [Supplementary Note 1]

A deterioration determination method performed by a deterioration determination device that determines deterioration of a structure having a plurality of surface members defining an internal space, the deterioration determination method including:
receiving an input of displacement information regarding displacement of a target region in which a direction of the displacement changes according to deterioration of the structure in a predetermined surface member among the plurality of surface members; and
determining whether the structure is deteriorated on the basis of the displacement information.

### [Supplementary Note 2]

The deterioration determination method according to supplementary note 1,
in which the displacement information includes information indicating displacement that changes over time,
the deterioration determination method further includes a smoothing step of smoothing a change over time of the displacement, and
the determination step includes a step of determining whether a time derivative of smoothed displacement that is the displacement in which the change over time has been smoothed is greater than 0 when the displacement to the outside of the structure in the target region is positive displacement, determining that the structure is not deteriorated when the time derivative of the smoothing displacement is determined to be greater than 0, and determining that the structure is deteriorated when the time derivative of the smoothing displacement is determined to be equal to or less than 0.

### [Supplementary Note 3]

The deterioration determination method according to supplementary note 2, in which the determination step includes determining whether the smoothed displacement from an initial position of the target region is greater than 0 when the displacement to the outside of the structure in the target region is positive displacement, and determining that the structure is deteriorated when the smoothed displacement is determined to be equal to or less than 0.

### [Supplementary Note 4]

The deterioration determination method according to any one of supplementary notes 1 to 3,
in which the plurality of surface members form a corner portion, and
the target region is a part of the predetermined surface member and is a region on a side of the corner portion.

### [Supplementary Note 5]

The deterioration determination method according to supplementary note 4, in which the target region is a region on the side of the corner portion from a deflection point of a bending moment of when deterioration does not occur in the structure in the predetermined surface member.

### [Supplementary Note 6]

The deterioration determination method according to any one of supplementary notes 1 to 5, in which the displacement information is signal information indicating displacement of the target region measured by a displacement measuring device or image information indicating an image of the target region captured by an imaging device.

### [Supplementary Note 7]

A deterioration determination device that determines deterioration of a structure having a plurality of surface members defining an internal space, the deterioration determination device including a controller, in which the controller
receives an input of displacement information regarding displacement of a target region in which a direction of the displacement changes according to deterioration of the structure in a predetermined surface member among the plurality of surface members, and
determines whether the structure is deteriorated on the basis of the displacement information.

### [Supplementary Note 8]

A non-transitory storage medium storing a program that is executable by a computer, the non-transitory storage medium causing the computer to operate the deterioration determination method according to any one of supplementary notes 1 to 6.

All documents, patent applications, and techniques described in the present specification are herein incorporated by reference to the same extent as if each individual document, patent application, and technique were specifically and individually described to be incorporated by reference.

Although the above-described embodiments have been described as representative examples, it is apparent to those skilled in the art that many modifications and substitutions can be made within the spirit and scope of the present disclosure. Therefore, it should not be understood that the present invention is limited by the above-described embodiments, and various modifications or changes can be made without departing from the scope of the claims.

### REFERENCE SIGNS LIST

1 Deterioration determination device
2 Structure
2a Target region
2b Non-target region
11 Input unit
12 Region determination unit
13 Storage unit
14 Displacement detection unit
Smoothing unit
16 Determination unit
17 Output unit
21 Upper surface member
22 Side surface member
23 Lower surface member
24 Corner portion
31 Cable
32 Distribution member
33 Support member
34 Terminal box
101 Computer
110 Processor
120 ROM
130 RAM
140 Storage
150 Input unit
160 Output unit
170 Communication interface
180 Bus

1. A deterioration determination method performed by a deterioration determination device that determines deterioration of a structure having a plurality of surface members defining an internal space, the deterioration determination method comprising:
receiving an input of displacement information regarding displacement of a target region in which a direction of the displacement changes according to deterioration of the structure in a predetermined surface member among the plurality of surface members; and
determining whether the structure is deteriorated based on the displacement information.

2. The deterioration determination method according to claim 1,
wherein the displacement information includes information indicating the displacement that changes over time,
the deterioration determination method further comprises smoothing a change over time of the displacement, and
determining whether a time derivative of smoothed displacement that is the displacement in which the change over time has been smoothed is greater than 0 when the displacement to the outside of the structure in the target region is positive displacement, determining that the structure is not deteriorated when the time derivative of the smoothing displacement is determined to be greater than 0, and determining that the structure is deteriorated when the time derivative of the smoothing displacement is determined to be equal to or less than 0.

3. The deterioration determination method according to claim 2, wherein determining whether the smoothed displacement from an initial position of the target region is greater than 0 when the displacement to the outside of the structure in the target region is positive displacement, and determining that the structure is deteriorated when the smoothed displacement is determined to be equal to or less than 0.

4. The deterioration determination method according to claim 1,
wherein the plurality of surface members form a corner portion, and
the target region is a part of the predetermined surface member and is a region on a side of the corner portion.

5. The deterioration determination method according to claim 4, wherein the target region is a region on the side of the corner portion from a deflection point of a bending moment of when deterioration does not occur in the structure in the predetermined surface member.

6. The deterioration determination method according to claim 1, wherein the displacement information is signal information indicating displacement of the target region measured by a displacement measuring device or image information indicating an image of the target region captured by an imaging device.

7. A deterioration determination device that determines deterioration of a structure having a plurality of surface members defining an internal space, the deterioration determination device comprising:
receiving an input of displacement information regarding displacement of a target region in which a direction of the displacement changes according to deterioration of the structure in a predetermined surface member among the plurality of surface members; and
determining whether the structure is deteriorated based on the displacement information.

8. (canceled)

9. The deterioration determination device according to claim 7,
wherein the displacement information includes information indicating the displacement that changes over time,
the deterioration determination method further comprises smoothing a change over time of the displacement, and
determining whether a time derivative of smoothed displacement that is the displacement in which the change over time has been smoothed is greater than 0 when the displacement to the outside of the structure in the target region is positive displacement, determining that the structure is not deteriorated when the time derivative of the smoothing displacement is determined to be greater than 0, and determining that the structure is deteriorated when the time derivative of the smoothing displacement is determined to be equal to or less than 0.

10. The deterioration determination device according to claim 9, wherein determining whether the smoothed displacement from an initial position of the target region is greater than 0 when the displacement to the outside of the structure in the target region is positive displacement, and determining that the structure is deteriorated when the smoothed displacement is determined to be equal to or less than 0.

11. The deterioration determination method according to claim 7,
wherein the plurality of surface members form a corner portion, and
the target region is a part of the predetermined surface member and is a region on a side of the corner portion.

12. The deterioration determination method according to claim 11, wherein the target region is a region on the side of the corner portion from a deflection point of a bending moment of when deterioration does not occur in the structure in the predetermined surface member.

13. The deterioration determination method according to claim 7, wherein the displacement information is signal information indicating displacement of the target region measured by a displacement measuring device or image information indicating an image of the target region captured by an imaging device.

14. A computer-readable non-transitory recording medium storing computer-executable program instructions that when executed by a processor cause a computer to execute a deterioration determination method comprising:
receiving an input of displacement information regarding displacement of a target region in which a direction of the displacement changes according to deterioration of the structure in a predetermined surface member among the plurality of surface members; and
determining whether the structure is deteriorated based on the displacement information.

15. The computer-readable non-transitory recording medium according to claim 14 wherein the deterioration determination method further comprises:
wherein the displacement information includes information indicating the displacement that changes over time,
the deterioration determination method further comprises smoothing a change over time of the displacement, and
determining whether a time derivative of smoothed displacement that is the displacement in which the change over time has been smoothed is greater than 0 when the displacement to the outside of the structure in the target region is positive displacement, determining that the structure is not deteriorated when the time derivative of the smoothing displacement is determined to be greater than 0, and determining that the structure is deteriorated when the time derivative of the smoothing displacement is determined to be equal to or less than 0.

16. The computer-readable non-transitory recording medium according to claim 14 wherein the deterioration determination method further comprises:
determining whether the smoothed displacement from an initial position of the target region is greater than 0 when the displacement to the outside of the structure in the target region is positive displacement, and determining that the structure is deteriorated when the smoothed displacement is determined to be equal to or less than 0.

17. The computer-readable non-transitory recording medium according to claim 14 wherein the deterioration determination method further comprises:
wherein the plurality of surface members form a corner portion, and
the target region is a part of the predetermined surface member and is a region on a side of the corner portion.

18. The computer-readable non-transitory recording medium according to claim 17 wherein the deterioration determination method further comprises:
wherein the target region is a region on the side of the corner portion from a deflection point of a bending moment of when deterioration does not occur in the structure in the predetermined surface member.

19. The computer-readable non-transitory recording medium according to claim 14 wherein the deterioration determination method further comprises:
wherein the displacement information is signal information indicating displacement of the target region measured by a displacement measuring device or image information indicating an image of the target region captured by an imaging device.

20. The deterioration determination method according to claim 1,
wherein the displacement information further comprising signal information indicating the displacement of the target area measured by a displacement measuring device such as a strain gauge, contact gauge, or displacement meter.

21. The deterioration determination method according to claim 7,
wherein the displacement information further comprising signal information indicating the displacement of the target area measured by a displacement measuring device such as a strain gauge, contact gauge, or displacement meter.
